(19) United States
(12) Patent Application Publication
(10) Pub. No.: US 2025/0266784 A1
(43) Pub. Date: Aug. 21, 2025

(54) METHOD FOR DETERMINING A TEMPERATURE OF AN ELECTRIC MACHINE

(71) Applicant: ZF Friedrichshafen AG, Friedrichshafen (DE)

(72) Inventors: Thomas NEHMEIER, Kruft (DE); Korbinian ZIMMERMANN, Stadtlauringen (DE)

(21) Appl. No.: 19/052,948

(22) Filed: Feb. 13, 2025

(30) Foreign Application Priority Data
Feb. 20, 2024 (DE) 10 2024 201 511.3

(51) Int. Cl. H02P 29/60; G01K 7/36; H02P 23/00

(52) U.S. Cl. CPC H02P 29/60; G01K 7/36; H02P 23/0018

(57) ABSTRACT

Method for determining a temperature of an electric machine. The temperature of the electric machine, particularly a rotor temperature and/or a stator temperature, is determined by a thermal model, particularly based on at least one current parameter of the electric machine and/or a power dissipation parameter of the electric machine. A test temperature is determined by a test model deviating from the thermal model, a temperature increment is determined depending on a deviation between the temperature determined by the thermal model and the test temperature, and the thermal model is changed based on the temperature increment.

### BACKGROUND OF THE INVENTION

### 1. Field of the Invention

The disclosure is directed to a method for determining a temperature of an electric machine, particularly for a motor vehicle, wherein the temperature of the electric machine, particularly a rotor temperature and/or a stator temperature, is determined by a thermal model, particularly based on at least one current parameter of the electric machine and/or a power dissipation parameter of the electric machine.

### 2. Description of Related Art

Methods for determining a temperature, particularly the rotor temperature and/or the stator temperature, of an electric machine of a motor vehicle, particularly of an electric machine of the motor vehicle that is constructed as a drive device, are known in principle from the prior art. A thermal model which can be configured in any desired manner in principle, for example, as AI model, nodal model or the like, is usually used for this purpose. The thermal model is usually based on the consideration of at least one electrical parameter of the electric machine, particularly a current parameter and/or a parameter of the electric machine describing the power dissipation. Alternatively or additionally, the thermal model can also be based on at least one cooling parameter, for example, a coolant temperature, particularly a cooling water temperature or an oil temperature. In other words, with knowledge of the input values, for example, the current parameter and/or power dissipation parameter, of the electric machine, the temperature development in the electric machine can be determined through the thermal model.

In this regard, it is further known that in such a determination of the temperature of the electric machine, the temperature model maps or models the behavior of the electric machine. This assumes that the real electric machine behaves to some extent like the modeled electric machine. Since the model behavior is based, for example, on historical or empirical data of a measured electric machine, variations which may occur in the production process of electric machines and accordingly lead to a deviation of an individual electric machine from the model behavior are usually not taken into account. As a result, the real behavior of the electric machine can deviate from the model behavior owing to manufacturing tolerances, component variation and the like. Changes in the real electric machine can also occur over its lifetime, for example, due to aging of components of the electric machine, and this can also lead to a deviation from the model behavior. As a result, the determined temperature which, as was described, is determined on the basis of a model deviates from the real temperature and the determination error is therefore introduced in the operation of the electric machine.

### SUMMARY OF THE INVENTION

It is the object of one aspect of the invention to provide a method for determining a temperature of an electric machine which is improved over the prior art and in which, in particular, deviations from a model behavior can be taken into account.

As has been described, one aspect of the invention is directed to a method for determining a temperature of an electric machine, particularly an electric machine of a motor vehicle. In particular, the electric machine can be used as a traction drive or drive device in the motor vehicle. The temperature which is to be determined by the method can be, in particular, the rotor temperature and/or the stator temperature of the electric machine. The temperature is determined in principle by a thermal model which is based in particular on at least one current parameter of the electric machine and/or a power dissipation parameter of the electric machine.

One aspect of the invention is based on the insight that a test temperature is determined by a test model deviating from the thermal model, and the thermal model is changed based on the temperature increment. Accordingly, it is proposed by way of the invention that, in addition to the determination of the temperature by the thermal model, a test model is utilized to determine a test temperature. The test model differs from the thermal model. When the real electric machine corresponds to the model behavior, identical results are obtained by the test model and thermal model. Therefore, by the test model, the test temperature can be determined in some other way than that carried out by the thermal model. In other words, the same temperature of the electric machine can be determined in different ways and, therefore, it can be compared whether the two models, i.e., the thermal model and the test model, deliver the same results. If there is a deviation of the electric machine from the model behavior of the electric machine, the test temperature will deviate from the determined temperature. Depending on the deviation, a temperature increment can be determined by which the thermal model can be changed to take into account the deviation between the model behavior and the real behavior.

In other words, when the test temperature deviates from the determined temperature, i.e., when the test model and the thermal model deliver different results, a temperature increment is determined and the thermal model is changed based on the temperature increment so that the results of the thermal model can be better adapted to the behavior of the real electric machine. In particular, this allows the thermal model to be used in principle for determining the temperature of the electric machine, but the results can be adapted based on the determination of the test model.

Therefore, no change occurs in the basic determination of the temperature of the electric machine because the basic determination of the temperature is carried out by the thermal model, but an adaptation of the results of the thermal model is allowed to some extent. Therefore, the test model is used in particular only for checking or for (minor) correction of the thermal model, namely, by the temperature increment. The temperature increment can be positive or negative in principle and can be incorporated in substantially any desired manner in the modeling by the thermal model, or the thermal model can be correspondingly changed. In particular, the temperature which is output by the thermal model is increased or decreased by the temperature increment. The temperature increment is limited in particular with respect to its amount so that there is no direct adaptation of the output temperature or determined temperature to the test temperature. Rather, the change in the thermal model is only carried out in direction of the test temperature by the temperature increment, for example, limited to a maximum value, particularly, 0.1 K to 2 K, preferably 0.5 K to 1 K. In other words, the temperature increment and temperature difference are different.

As has already been described, the test model diverges from the thermal model. In particular, the mechanisms with which the thermal model determines the temperature and the test model determines the test temperature differ from one another. It can be provided in the method that the test model is based on a temperature flux monitor, and the test temperature is determined based on a magnetic flux of the electric machine. The thermal model can determine the determined temperature of the electric machine particularly based on electrical parameters, particularly the currents flowing in the electric machine or power dissipation parameters, i.e., the power dissipation occurring in the electric machine. In contrast, the test model considers the magnetic flux of the electric machine so that the test temperature can ultimately be determined based on the magnetic flux of the electric machine. As is known, the magnetic flux in the electric machine is temperature-dependent so that the test temperature of the electric machine can be deduced based on the magnetic flux presently existing in the electric machine so that the test model can determine the test temperature. The determined temperature can also be referred to as model temperature within the framework of the present application.

It is advantageous that, contrary to a temperature determination based on current parameters or power dissipation, a component variation, i.e., a tolerance-related deviation of the electric machine, and an aging of the electric machine can be taken into account in the test model. When such a component variation or aging occurs, this changes the magnetic flux of the electric machine and, therefore, the test temperature determined with the test model in a determined operating state or during a determined magnetic flux.

Accordingly, a change in the temperature behavior of the electric machine over the lifetime can be included through the test model and, owing to the possibility of changing the thermal model by which the actual temperature determination is carried out, the thermal model can be changed through the test model, and the thermal model can therefore also be adapted or updated over the lifetime of the electric machine. In particular, a temporary model which can be applied only in determined operating ranges of the electric machine, in particular determined speed ranges, can be used as test model. In contrast, the thermal model can be applied globally, i.e., in all operating ranges of the electric machine.

In a further development of the method, it can be provided that the testing temperature is determined in a particular operating state of the electric machine, in particular at least at a determined speed or at least in a determined speed range. In particular, it can be taken into account that, depending on the test model, this test model delivers optimal results in a determined operating state, for example, in a determined speed range. Further, the test model can comprise at least two submodels which are designed for determined operating states, for example, a first submodel for a determined first speed or a determined first speed range and a second submodel for a determined second speed or a determined second speed range.

When the electric machine is operated at the determined speed or in the determined speed range, the determined temperature is determined by the thermal model. Further, the test temperature is determined by the test model in the determined operating state, i.e., at the determined speed or in the determined speed range. The change in the thermal model when there is a deviation between the test temperature and determined temperature can accordingly be carried out for determined operating states, for example, for various speeds or various speed ranges.

As was already described at the start, the test temperature, which is obtained from the test model and the determined temperature which is obtained from the thermal model are compared. A temperature difference can be determined by the comparison in case the test temperature deviates from the determined temperature. In other words, the temperature difference equals zero when the test temperature corresponds to the determined temperature. According to a further development of the method, at least one temperature difference limit value can be specified, and the thermal model is only changed when the test temperature deviates from the determined temperature by more than the temperature difference limit value. This ensures that slight differences between the test temperature and the determined temperature do not lead directly to a change in the thermal model, but rather the thermal model is only adapted when a significant difference exists between the results of the test model and those of the thermal model. The temperature difference limit value can be used, for example, symmetrically for a temperature difference upper limit and a temperature difference lower limit, or two different temperature difference limit values can be specified for a temperature difference upper limit and the temperature difference lower limit. A value in a range of from 1-10 K, particularly 2-5 K, for example, 3 K, can be used as temperature difference limit value.

Moreover, the method can be further developed such that the change of the thermal model is carried out based on a characteristic diagram or a characteristic curve. As has been described, the determination of the temperature by the thermal model and the determination of the test temperature by the test model can be carried out for different operating states. The results can be stored correspondingly in a characteristic diagram or a characteristic curve.

In other words, a temperature increment can be specified for the different operating states and the thermal model can be correspondingly changed, and the change can be stored in the characteristic diagram or characteristic curve. In particular, the comparison of the test temperature and the determined temperature can be carried out for every operating state, for example, every determined speed or every determined speed range, so that when the temperature difference limit value is exceeded an adaptation of the thermal model can be carried out, namely, for this speed range or this speed. When the speed or speed range is resumed again in the further operation of the electric machine, the changed thermal model can already be used for determining the temperature.

It can further be provided in the method that a change limit is specified, wherein, starting from a base value, the thermal model, particularly the determined temperature, is changeable only within the change limit, particularly +/−10 K or between −5 K and +10 K or −10 K and +5 K. The “base value” can be the temperature determined by the thermal model for the operating state without adapting the thermal model. The thermal model can be changed by the test model, particularly for the described operating state, only to the extent that, in the operating state, the determined temperature deviates from the base value by the change limit after the change of the thermal model. In particular, as a result of the change limit, the test model, which is less accurate in principle than the thermal model used for determining the determined temperature, is prevented from causing a change in the thermal model within defined limits. In other words, the thermal model which is used for determining the determined temperature of the electric machine is trusted in principle, and a tendency to change the thermal model by the test model, for example, based on component variation or aging of the electric machine, is permitted, but the thermal model cannot be changed beyond the change limit.

Further, state information of the electric machine can be generated in the method based on a quantity of temperature increments. For example, the number of temperature increments that was generated for adapting the thermal model can be taken into account. The quantity of temperature increments or the temperature increments, respectively, can be stored and retrieved, for example, in a control device of the electric machine. Correspondingly, when there is a plurality of temperature increments by which the thermal model was adapted over the course of operation, it can be assumed that there was a high deviation of the electric machine from the model behavior that was corrected by the test model. As has been described, the deviation can occur in principle because of component variation or due to aging. In this respect, the corresponding phenomena which lead to a change in the thermal model can also cancel one another out or balance one another out so that, for example, when the electric machine is put into operation, a change in the thermal model occurs due to component variation, which change is subsequently canceled out or balanced out due to aging phenomena by corresponding adaptation of the thermal model so that the base value of the thermal model is returned to again.

Further, state information can be generated in the method based on time information of at least one temperature increment. In particular, the time information indicates when the temperature increment was generated or when the individual temperature increments were generated or when the thermal model was changed based on the temperature increment. In particular, this allows the state information to be made more precise because the time at which the temperature increment was generated and the thermal model was changed, for example, with reference to the lifetime of the electric machine, can be determined based on the time information of the temperature increments. In this way, temperature increments based on component variation or a manufacturing tolerance can be distinguished from temperature increments which were first required over the course of operation of the electric machine due to aging of components of the electric machine.

In addition to the described method, the invention is directed to a determination device for determining a temperature of an electric machine, particularly for a motor vehicle. The determination device is configured to determine the temperature of the electric machine, particularly a rotor temperature and/or a stator temperature, by a thermal model, particularly based on at least one current parameter of the electric machine and/or a power dissipation parameter of the electric machine, and the determination device is configured to determine a test temperature by a test model deviating from the thermal model, to determine a temperature increment depending on a deviation between the temperature determined by the thermal model and the test temperature, and to change the thermal model based on the temperature increment. The determination device can be constructed in particular as part of a control device or computing device or can comprise the latter.

One aspect of the invention is further directed to a motor vehicle that comprises an electric machine and a determination device described above.

All of the advantages, details and features which have been described in relation to the method are fully transferable to the motor vehicle and the determination device.

### BRIEF DESCRIPTION OF THE DRAWINGS

The invention will be described in the following based on embodiment examples referring to the figures. The figures are schematic representations and show:

FIG. 1 is a schematic view of a motor vehicle; and

FIG. 2 is a schematic flow chart for a method for determining a temperature of an electric machine of a motor vehicle.

### DETAILED DESCRIPTION OF THE PRESENTLY PREFERRED EMBODIMENTS

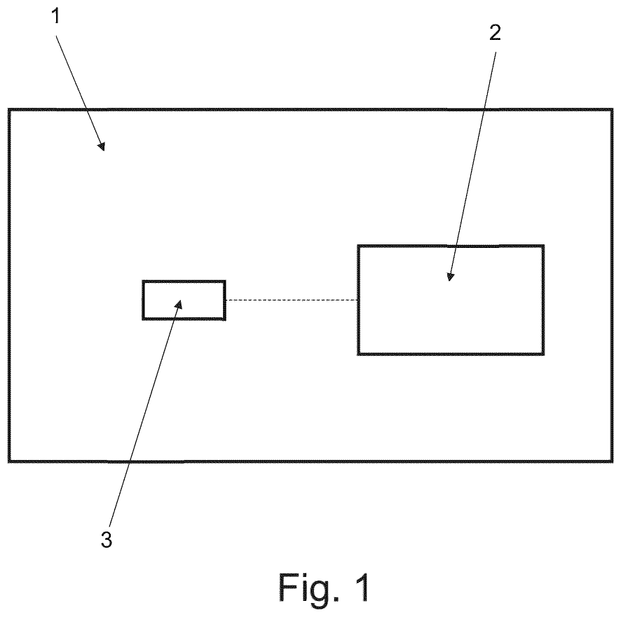

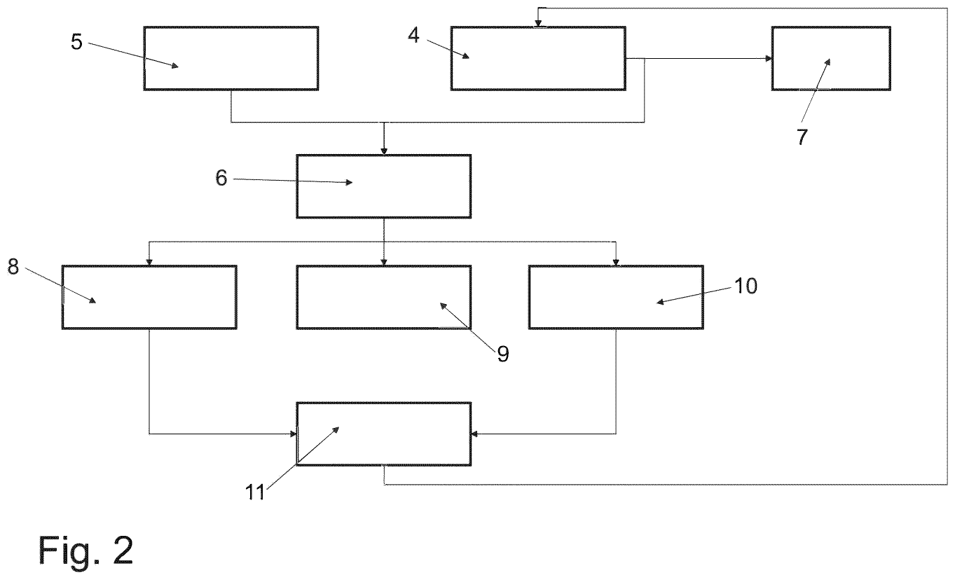

FIG. 1 schematically shows a motor vehicle 1, which comprises an electric machine 2 and a determination device 3. The determination device 3 can be constructed as a component part of a control device or computing device of the motor vehicle 1 or, alternatively, can be connected to or have the latter. The determination device 3 is configured to determine the temperature of the electric machine 2, particularly a rotor temperature and/or a stator temperature of the electric machine 2. The determination device 3 is configured in principle to carry out the method described herein for determining the temperature of the electric machine 2. The method is described in the following referring to FIG. 2. The description is transferable to the determination device 3 and the motor vehicle 1 from FIG. 1 in a corresponding manner.

In the flowchart shown schematically in FIG. 2, block 4 represents the thermal model, or the thermal model is carried out in block 4, for example, by the determination device 3. The thermal model is arbitrary in principle and can comprise, for example, an AI model, a nodal model and the like and is based, for example, on cooling parameters and/or on current parameters of the electric machine 2, particularly on power dissipation parameters. The thermal model is configured in block 4 to determine the temperature of the electric machine 2.

Further, block 5 in the flowchart shows a test model, which is configured to determine a test temperature. The test model is different than the thermal model and diverges from it. The test model is based in particular on a temperature flux monitor or on a signal injection model so that the test temperature which is determined by the test model in block 5 can be based on the magnetic flux of the electric machine 2. The test temperature determined in block 5 by the test model is fed to block 6, to which the determined temperature from the thermal model is also fed. Further, the determined temperature from the thermal model is fed from block 4 to a block 7 which, by way of example, stands for the control of the operation of the electric machine 2. Accordingly, it is clear that only the thermal model is decisive for the operation of the electric machine 2, that is, only the determined temperature from the thermal model is used for controlling the electric machine 2.

The test temperature fed to block 6 and the determined temperature fed to block 6 are compared with one another in block 6. In particular, the temperature difference is formed. Depending on the temperature difference, block 6 proceeds to one of blocks 8-10. In particular, a temperature difference limit value is specified in block 6. If the test temperature differs from the determined temperature by less than the temperature difference limit value, i.e., the temperature difference is less than the temperature difference limit value, block 6 proceeds to block 9 in which no change in the thermal model takes place.

If the temperature difference exceeds the temperature difference limit value, block 6 proceeds to block 8 in case the test temperature is less than the determined temperature, and block 6 proceeds to block 10 in case the test temperature is greater than the determined temperature. In both cases, the same amount of temperature difference limit value can be used, for example, −3 K and +3 K, or a first temperature difference limit value and the second temperature difference limit value can be specified, i.e., different temperature difference limit values can be defined for positive temperature differences and negative temperature differences. In every case, block 6 proceeds to block 9 in case the temperature difference limit value is not exceeded and, depending on a positive temperature difference or negative temperature difference, block 6 may proceed to block 8 or from block 6 to block 10 selectively.

In block 8 and block 10, corresponding temperature increments by which the thermal model is to be changed are specified or generated. The temperature increments are therefore limited with respect to their amount. Regardless of how much the determined temperature differs from the test temperature in block 6, either a positive temperature increment is generated in block 8 or a negative temperature increment is generated in block 10. The temperature increment can be, for example, 0.1 K to 2 K, particularly 0.5 K to 1 K.

For example, it can be specified in block 6 that the test temperature is 10 K lower than the determined temperature, and that the temperature difference limit value was exceeded. As described above, block 6 then proceeds to block 8 in which a positive temperature increment by which to change the thermal model, for example, 0.5 K, is generated. If it is specified in block 6 that the test temperature, for example, lies 20 K higher than the determined temperature, block 6 can proceed, as described, to block 10 in which a negative temperature increment is generated, for example, −0.5 K, in order to correspondingly change the thermal model. Accordingly, it remains ensured that the change in the thermal model through the generation of temperature increments takes place only to a slight extent so that an iterative run-through of the method described herein is possible in order to make gradual changes in the thermal model.

Subsequently, block 6 or block 10 proceeds to block 11 in which the change in the thermal model is carried out based on a characteristic diagram or a characteristic curve. Alternatively, the adaptation of the thermal model can also flow directly from block 8 or block 10 to block 4 in order to directly adapt the thermal model.

Optionally, the temperature increment can be stored in block 11 for the present operating state so that the thermal model for this determined operating state, for example, a determined speed or a determined speed range, can be changed. When operation of the electric machine 2 is resumed in the determined operating state, the thermal model is already operated with the temperature increment taken into account. The method described herein can be carried out throughout all operating states of the electric machine 2 so that corresponding temperature increments can be stored in block 11 for diverse operating states. In this regard, a selection of different submodels of the test model can be carried out in block 5. The submodels of the test model are, in particular, temporary models which are suitable for determined operating states. Depending on the present operating state, for example, the suitable submodel can be selected as test model.

Further, a change limit can be specified in block 8, 10, or 11. In this regard, changes in the thermal model are permitted only within the change limit. For example, a base value can be specified for a determined operating state, particularly that temperature outputted in the operating state by the thermal model, insofar as the thermal model was not changed by temperature increments. The change limit can be, for example, 10 K. This means that as a result of the method described herein, particularly by the test model, the thermal model can only be changed up to a maximum of +/−10 K in order to take into account component variation or aging or other changes in the electric machine 2. Accordingly, it remains ensured in particular that the thermal model cannot be changed excessively by the test model.

Further optionally, the generated temperature increments can be stored in block 11. In particular, every temperature increment can be provided with a timestamp so that the time when the temperature increment in question was generated can be displayed throughout the operation of the electric machine 2 in order to adapt the thermal model. Accordingly, state information of the electric machine 2 can be determined in block 11 which indicates how the state of the electric machine 2 has changed or how it deviates from a model behavior.

For example, the quantity of temperature increments can be taken into account in order to specify the extent to which the thermal model has been changed. The state information, particularly the quantity of temperature increments, is ultimately a measure of the deviation of the real electric machine 2 from a standardized behavior or model behavior. Further, it can be calculated based on time information, particularly the timestamp of each temperature increment, whether the change in the thermal model or the generation of the temperature increments took place at the start of the operation of the electric machine 2 and was based on a component variation of the electric machine 2 or whether the temperature increments were generated throughout the operation of the electric machine 2 and the corresponding reason may consist in the aging of the electric machine 2.

The method shown herein can be carried out continuously in particular so that the determined temperature which is outputted by the thermal model can always be compared with the corresponding test temperature from the test model. If temperature increments were generated and stored in the characteristic curve or in the characteristic diagram, this is fed subsequently to block 4 so that the thermal model can be correspondingly changed and subsequently the changed determined temperature can be fed to block 7 for controlling the electric machine 2.

As has been described, a temperature, particularly the rotor temperature and the stator temperature, is determined by the thermal model. The test model is capable of determining the rotor temperature as test temperature particularly based on the observed magnetic flux. Accordingly, in particular, the rotor temperature determined by the thermal model based on the test temperature can be changed as was described above. In this regard, a feedback between the rotor temperature and the stator temperature in the thermal model is possible or a change in the rotor temperature can be converted at least indirectly into a change in the stator temperature.

Thus, while there have shown and described and pointed out fundamental novel features of the invention as applied to a preferred aspect thereof, it will be understood that various omissions and substitutions and changes in the form and details of the devices illustrated, and in their operation, may be made by those skilled in the art without departing from the spirit of the invention. For example, it is expressly intended that all combinations of those elements and/or method steps which perform substantially the same function in substantially the same way to achieve the same results are within the scope of the invention. Moreover, it should be recognized that structures and/or elements and/or method steps shown and/or described in connection with any disclosed form or embodiment of the invention may be incorporated in any other disclosed or described or suggested form or embodiment as a general matter of design choice. It is the intention, therefore, to be limited only as indicated by the scope of the claims appended hereto.

1. A method for determining a temperature of an electric machine,
determining the temperature by a thermal model, based on at least one current parameter of the electric machine and/or a power dissipation parameter of the electric machine, determining a test temperature by a test model deviating from the thermal model;
determining a temperature increment depending on a deviation between the temperature determined by the thermal model and the test temperature; and
changing the thermal model based on the temperature increment.

2. The method according to claim 1,
wherein the test model is based on a temperature flux monitor and/or on a signal injection model, and
wherein the test temperature is determined based on a magnetic flux of the electric machine.

3. The method according to claim 1, wherein the test temperature is determined in a particular operating state of the electric machine.

4. The method according to claim 1,
wherein at least one temperature difference limit value is specified, and
wherein the thermal model is only changed when the test temperature deviates from a determined temperature by more than the at least one temperature difference limit value.

5. The method according to claim 1, wherein a change of the thermal model is carried out based on a characteristic diagram or a characteristic curve.

6. The method according to claim 1,
wherein a change limit is specified,
wherein, starting from a base value, the thermal model is changeable only within the change limit of +/−10 K.

7. The method according to claim 1, wherein state information of the electric machine is generated based on a quantity of temperature increments.

8. The method according to claim 7, wherein the state information is generated based on time information of at least one temperature increment.

9. A determination device configured to determine a rotor temperature and/or a stator temperature of an electric machine,
wherein the determination device is configured to determine a temperature of the electric machine, by thermal model, based on at least one current parameter of the electric machine and/or a power dissipation parameter of the electric machine, and
wherein the determination device is configured to determine a test temperature by a test model deviating from the thermal model and to determine a temperature increment depending on a deviation between a temperature determined by the thermal model and the test temperature, and to change the thermal model based on the temperature increment.

10. A motor vehicle comprising:
an electric machine; and
a determination device configured to determine a rotor temperature and/or a stator temperature of the electric machine,
wherein the determination device is configured to determine a temperature of the electric machine, by thermal model, based on at least one current parameter of the electric machine and/or a power dissipation parameter of the electric machine, and
wherein the determination device is configured to determine a test temperature by a test model deviating from the thermal model and to determine a temperature increment depending on a deviation between the temperature determined by the thermal model and the test temperature, and to change the thermal model based on the temperature increment.
